(19) United States
(12) Patent Application Publication
(10) Pub. No.: US 2012/0229371 A1
(43) Pub. Date: Sep. 13, 2012

(54) Screen Rotation Lock Methods and Systems

(75) Inventor: Kim Yeung Sip, Taipei Hsien (TW)

(73) Assignee: ACER INCORPORATED, Taipei Hsien (TW)

(21) Appl. No.: 13/102,482

(22) Filed: May 6, 2011

(30) Foreign Application Priority Data
Mar. 8, 2011 (TW) 100107691

(51) Int. Cl. G09G 5/00

(52) U.S. Cl. 345/156

(57) ABSTRACT

Screen rotation lock methods and systems are provided. First, an angle between a specific plane of an electronic device and an absolute horizontal plane is detected using at least one sensor, and it is determined whether the angle equals to a specific angle. When the angle equals to the specific angle, a screen auto-rotation function of the electronic device is disabled.

### CROSS REFERENCE TO RELATED APPLICATIONS

This Application claims priority of Taiwan Patent Application No. 100107691, filed on Mar. 8, 2011, the entirety of which is incorporated by reference herein.

### BACKGROUND OF THE INVENTION

1. Field of the Invention

The disclosure relates generally to screen rotation lock methods and systems, and, more particularly to methods and systems that automatically lock a screen auto-rotation function of an electronic device according to the attitude of the electronic device.

2. Description of the Related Art

Recently, portable devices, such as tablet computers, mobile phones, smart phones, and PDAs (Personal Digital Assistants), have become more and more technically advanced and multifunctional. For example, a portable device may have a telecommunications, an email message, an advanced address book management, a calendar management, a note management, a media playback, and various other functions. Due to increased convenience and functions of the devices, these devices have become basic life necessities.

In some handheld devices, it is popular to employ built-in sensors to detect the movement of devices, and accordingly perform related applications. For example, a user can view data, such as an image via the screen of a device. When the user rotates the electronic device, the sensor can detect a current direction of the electronic device, and rotate data or provide different data browsing modes according to the current direction of the electronic device.

Generally, users use a hand to hold devices vertically. For theses type of devices, the displayed content faces upright to the users, such that the users can easily view data. However, in some large portable devices, such as netbooks and tablet computers, users may need to place the devices on a plane for operation. Since the devices are placed on a plane, no direction can be determined as being a static upright direction. When the data in the screen of a device is frequently rotated due to vibrations or movements of the device, it becomes inconvenient for users to operate the device.

### BRIEF SUMMARY OF THE INVENTION

Screen rotation lock methods and systems are provided.

In an embodiment of a screen rotation lock method, an angle between a specific plane of an electronic device and an absolute horizontal plane is detected using at least one sensor, and it is determined whether the angle equals to a specific angle. When the angle equals to the specific angle, a screen auto-rotation function of the electronic device is disabled.

An embodiment of a screen rotation lock system includes at least one sensor and a processing unit. The sensor detects an angle between a specific plane of an electronic device and an absolute horizontal plane. The processing unit determines whether the angle equals to a specific angle. When the angle equals to the specific angle, the processing unit disables a screen auto-rotation function of the electronic device.

In some embodiments, it is determined whether the angle falls within a predefined tolerance angle range of the specific angle. When the angle falls within the predefined tolerance angle range of the specific angle, the screen auto-rotation function of the electronic device is disabled.

In some embodiments, when the angle equals to the specific angle, it is further determined whether the electronic device has maintained the angle for a period exceeding a predefined period. When the electronic device has maintained the angle for a period exceeding the predefined period, the screen auto-rotation function of the electronic device is disabled.

In some embodiments, after the screen auto-rotation function of the electronic device is disabled, a trigger is further received, and in response to the trigger, data in a screen of the electronic device is rotated. In some embodiments, the trigger may include a rotation command instructing the electronic device to perform the rotation operation, a vibration of the electronic device, or a gesture of an object on the screen of the electronic device.

Screen rotation lock methods may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a screen rotation lock system of the invention;

FIG. 2 is a flowchart of an embodiment of a screen rotation lock method of the invention;

FIG. 3 is a flowchart of another embodiment of a screen rotation lock method of the invention; and

FIG. 4 is a flowchart of another embodiment of a screen rotation lock method of the invention.

### DETAILED DESCRIPTION OF THE INVENTION

Screen rotation lock methods and systems are provided.

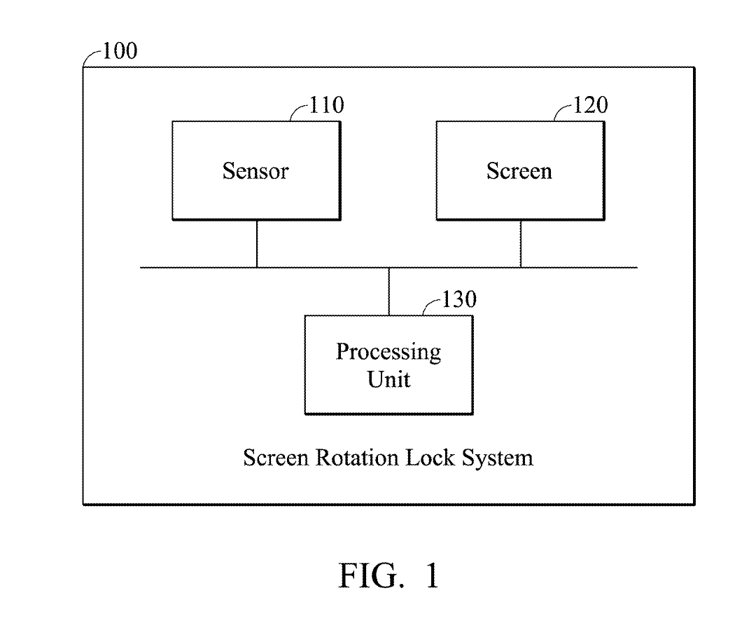

FIG. 1 is a schematic diagram illustrating an embodiment of a screen rotation lock method of the invention. The screen rotation lock system can be used in an electronic device such as tablet computer, PDA, smart phone, mobile phone, netbook, mini-notebook, or any other handheld device.

The screen rotation lock system 100 comprises at least one sensor 110, a screen 120, and a processing unit 130. The at least one sensor 110 may be a G-sensor, a gyroscope, and/or a magnetometer. The sensor 110 can detect the movement, position, and the attitude of the electronic device in the space. For example, in some embodiments, the sensor 110 can detect an angle between a specific plane of an electronic device, such as the plane where the screen 120 is located, and an absolute horizontal plane. The screen 120 can display related data, such as figures, and interfaces, and related contents. It is understood that, in some embodiments, the screen 120 can be integrated with a touch-sensitive device (not shown) to form a touch-sensitive screen. The touch-sensitive device has a touch-sensitive surface comprising sensors in at least one dimension to detect contact and movement of an input tool, such as a stylus or finger on the touch-sensitive surface. The processing unit 130 performs the screen rotation lock methods of the invention, which will be discussed further in the following paragraphs.

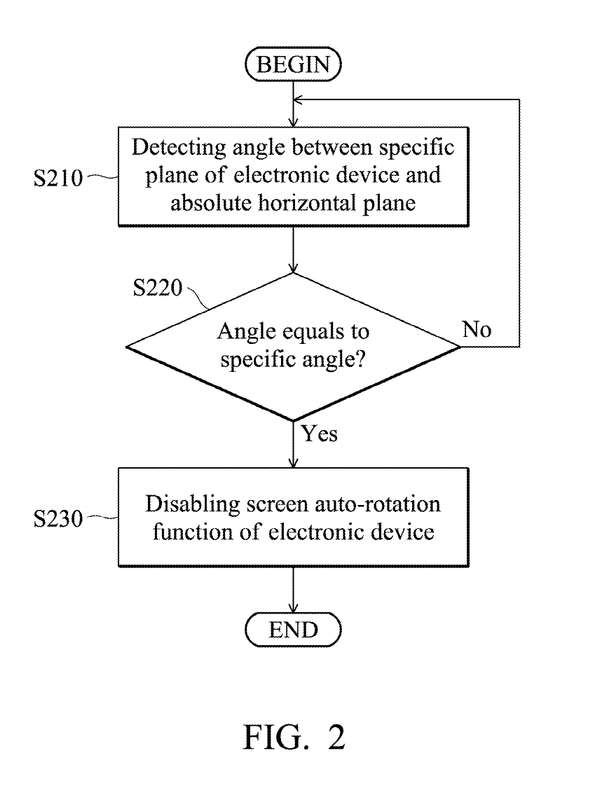

FIG. 2 is a flowchart of an embodiment of a screen rotation lock method of the invention. The screen rotation lock method can be used in an electronic device such as tablet computer, PDA, smart phone, mobile phone, netbook, mini-notebook, or any other handheld device.

In step S210, an angle between a specific plane of the electronic device and an absolute horizontal plane is detected using at least one sensor. It is understood that, in some embodiments, the specific plane may be a plane where the screen of the electronic device is located. In step S220, it is determined whether the angle equals to a specific angle. It is understood that, in some embodiments, the specific angle may be 0°. That is, it is determined whether the electronic device is horizontal to the absolute horizontal plane. If the angle does not equal to the specific angle (No in step S220), the procedure returns to step S210. When the angle equals to the specific angle (Yes in step S220), in step S230, a screen auto-rotation function of the electronic device is disabled. It is noted that, after the screen auto-rotation function of the electronic device is disabled, when the electronic device horizontally rotates, that is, the electronic device rotates and the screen of the electronic device is maintained to be perpendicular to the direction of gravity, the data displayed in the screen will not be rotated. It is understood that, in some embodiments, the specific angle may be set with a predefined tolerance angle range. When the angle between the specific plane of the electronic device and the absolute horizontal plane falls within the predefined tolerance angle range of the specific angle, it is also determined the angle equals to the specific angle, thus, the screen auto-rotation function of the electronic device is disabled.

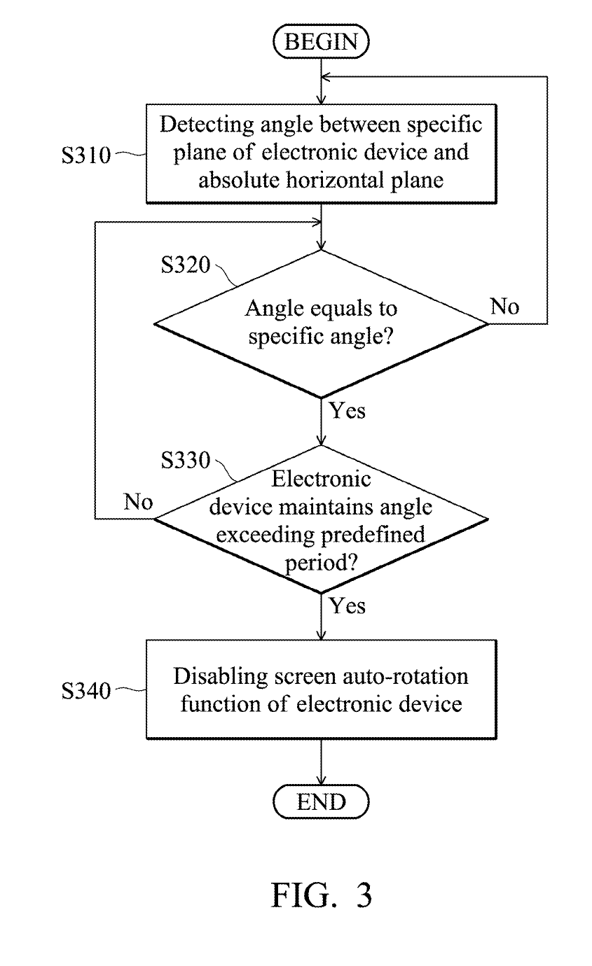

FIG. 3 is a flowchart of another embodiment of a screen rotation lock method of the invention. The screen rotation lock method can be used in an electronic device such as tablet computer, PDA, smart phone, mobile phone, netbook, mini-notebook, or any other handheld device.

In step S310, an angle between a specific plane of the electronic device and an absolute horizontal plane is detected using at least one sensor. Similarly, in some embodiments, the specific plane may be a plane where the screen of the electronic device is located. In step S320, it is determined whether the angle equals to a specific angle. Similarly, in some embodiments, the specific angle may be 0°. If the angle does not equal to the specific angle (No in step S320), the procedure returns to step S310. When the angle equals to the specific angle (Yes in step S320), in step S330, it is determined whether the electronic device has maintained the angle for a period exceeding a predefined period. When the electronic device does not maintain the angle for a period exceeding the predefined period (No in step S330), the procedure returns to step S320, and detection of the angle between the specific plane of the electronic device and the absolute horizontal plane is continued. When the electronic device has maintained the angle for a period exceeding the predefined period (Yes in step S330), in step S340, the screen auto-rotation function of the electronic device is disabled. Similarly, in some embodiments, the specific angle may be set with a predefined tolerance angle range. When the angle between the specific plane of the electronic device and the absolute horizontal plane falls within the predefined tolerance angle range of the specific angle, it is also determined that the angle equals to the specific angle, thus, the screen auto-rotation function of the electronic device is disabled.

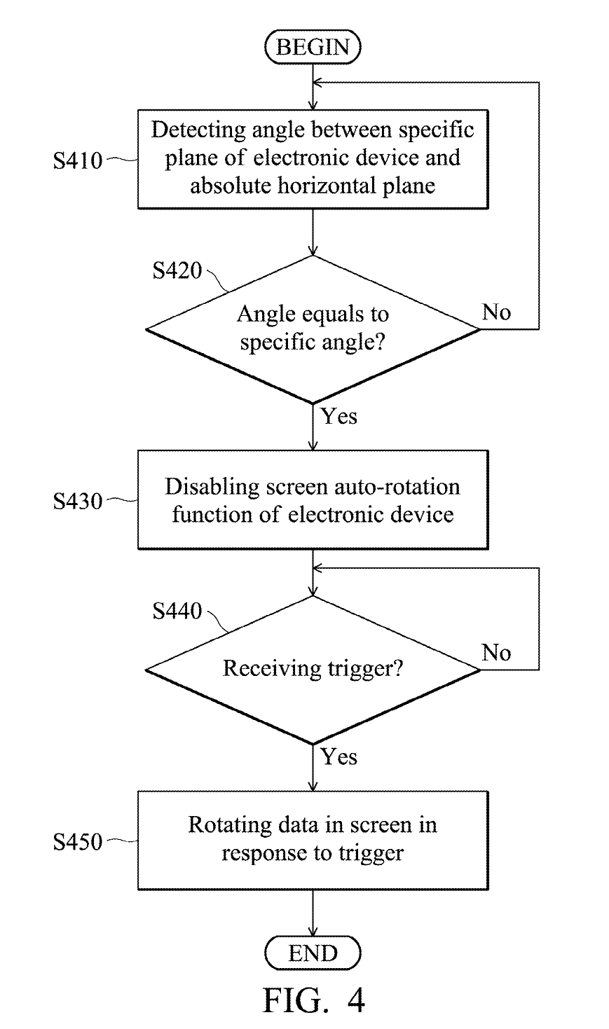

FIG. 4 is a flowchart of another embodiment of a screen rotation lock method of the invention. The screen rotation lock method can be used in an electronic device such as tablet computer, PDA, smart phone, mobile phone, netbook, mini-notebook, or any other handheld device.

In step S410, an angle between a specific plane of the electronic device and an absolute horizontal plane is detected using at least one sensor. Similarly, in some embodiments, the specific plane may be a plane where the screen of the electronic device is located. In step S420, it is determined whether the angle equals to a specific angle. Similarly, in some embodiments, the specific angle may be 0°. If the angle does not equal to the specific angle (No in step S420), the procedure returns to step S410. When the angle equals to the specific angle (Yes in step S420), in step S430, the screen auto-rotation function of the electronic device is disabled. Similarly, in some embodiments, the specific angle may be set with a predefined tolerance angle range. When the angle between the specific plane of the electronic device and the absolute horizontal plane falls within the predefined tolerance angle range of the specific angle, it is also determined that the angle equals to the specific angle, thus the screen auto-rotation function of the electronic device is disabled. It is understood that, in some embodiments, it is determined whether the electronic device has maintained the angle for a period exceeding a predefined period. When the electronic device has maintained the angle for a period exceeding the predefined period, the screen auto-rotation function of the electronic device is disabled. Then, in step S440, it is determined whether a trigger is received. It is understood that, in some embodiments, the trigger may be a rotation command instructing the electronic device to perform the rotation operation. In some embodiments, the rotation command can be input via the screen of the electronic device. In some embodiments, the trigger may be a vibration of the electronic device, and/or a gesture of at least one object on the screen of the electronic device. If no trigger is received (No in step S440), the procedure remains at step S440. If a trigger is received (Yes in step S440), in step 5450, in response to the trigger, the data in the screen of the electronic device is rotated. It is noted that, the rotation of the data in step 5450 is performed when the screen auto-rotation function of the electronic device is disabled. For example, users can use a finger to draw a curve or gesture from left to right on the touch-sensitive screen, thus, to rotate the data in the screen of the electronic device from left to right.

Therefore, the screen rotation lock methods and systems of the invention can automatically lock the screen auto-rotation function according to the attitude of the electronic device, thereby, being more convenient for users, eliminating determination of erroneous directions of a device.

Screen rotation lock methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed:

1. A screen rotation lock method for use in an electronic device, comprising:
detecting an angle between a specific plane of the electronic device and an absolute horizontal plane using at least one sensor;
determining whether the angle equals to a specific angle; and
when the angle equals to the specific angle, disabling a screen auto-rotation function of the electronic device.

2. The method of claim 1, wherein after the screen auto-rotation function is disabled, when the electronic device rotates and a screen of the electronic device is maintained to be perpendicular to the direction of gravity, the data displayed in the screen is not rotated.

3. The method of claim 1, wherein the specific plane is a plane where a screen of the electronic device is located.

4. The method of claim 1, further comprising:
determining whether the angle falls within a predefined tolerance angle range of the specific angle; and
when the angle falls within the predefined tolerance angle range of the specific angle, the screen auto-rotation function of the electronic device is disabled.

5. The method of claim 1, wherein when the angle equals to the specific angle, the method further comprises:
determining whether the electronic device has maintained the angle for a period exceeding a predefined period; and
when the electronic device has maintained the angle for a period exceeding the predefined period, the screen auto-rotation function of the electronic device is disabled.

6. The method of claim 1, wherein after the screen auto-rotation function is disabled, the method further comprises:
receiving a trigger; and
in response to the trigger, rotating data in a screen of the electronic device.

7. The method of claim 6, wherein the trigger comprises a rotation command instructing the electronic device to perform the rotation operation, a vibration of the electronic device, or a gesture of an object on the screen of the electronic device.

8. A screen rotation lock system for use in an electronic device, comprising:
at least one sensor detecting an angle between a specific plane of the electronic device and an absolute horizontal plane; and
a processing unit determining whether the angle equals to a specific angle, and when the angle equals to the specific angle, disabling a screen auto-rotation function of the electronic device.

9. The system of claim 8, further comprising a screen, wherein after the screen auto-rotation function is disabled, when the electronic device rotates and the screen of the electronic device is maintained to be perpendicular to the direction of gravity, the data displayed in the screen is not rotated.

10. The system of claim 8, wherein the specific plane is a plane where a screen of the electronic device is located.

11. The system of claim 8, wherein the processing unit further determines whether the angle falls within a predefined tolerance angle range of the specific angle, and when the angle falls within the predefined tolerance angle range of the specific angle, the processing unit disables the screen auto-rotation function of the electronic device.

12. The system of claim 8, wherein when the angle equals to the specific angle, the processing unit further determines whether the electronic device has maintained the angle for a period exceeding a predefined period, and when the electronic device has maintained the angle for a period exceeding the predefined period, the processing unit disables the screen auto-rotation function of the electronic device.

13. The system of claim 8, wherein after the screen auto-rotation function is disabled, the processing unit further receives a trigger, and in response to the trigger, rotates data in a screen of the electronic device.

14. The system of claim 13, wherein the trigger comprises a rotation command instructing the electronic device to perform the rotation operation, a vibration of the electronic device, or a gesture of an object on the screen of the electronic device.

15. A machine-readable storage medium comprising a computer program, which, when executed, causes a device to perform a screen rotation lock method, wherein the method comprises:
detecting an angle between a specific plane of the electronic device and an absolute horizontal plane using at least one sensor;
determining whether the angle equals to a specific angle; and
when the angle equals to the specific angle, disabling a screen auto-rotation function of the electronic device.
